(19) United States
(12) Patent Application Publication
(10) Pub. No.: US 2022/0222951 A1
(43) Pub. Date: Jul. 14, 2022

(54) 3D OBJECT DETECTION METHOD, MODEL TRAINING METHOD, RELEVANT DEVICES AND ELECTRONIC APPARATUS

(71) Applicant: Beijing Baidu Netcom Science Technology Co., Ltd., Beijing (CN)

(72) Inventors: Xiaoqing Ye, Beijing (CN); Hao Sun, Beijing (CN)

(73) Assignee: Beijing Baidu Netcom Science Technology Co., Ltd., Beijing (CN)

(21) Appl. No.: 17/709,283

(22) Filed: Mar. 30, 2022

(30) Foreign Application Priority Data
Aug. 25, 2021 (CN) 202110980060.4

(51) Int. Cl. G06V 20/64; G06V 10/40; G06T 7/50

(52) U.S. Cl. CPC G06V 20/64; G06V 10/40; G06T 2207/10024; G06T 2207/20081; G06T 2207/10028; G06T 7/50

(57) ABSTRACT

A 3D object detection method includes: obtaining a first monocular image; and inputting the first monocular image into an object model, and performing a first detection operation to obtain first detection information in a 3D space, wherein the first detection operation includes performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information, wherein the target learning parameter is used to present a difference degree between the first point cloud feature and a target point cloud feature of the first monocular image.

### CROSS-REFERENCE TO RELATED APPLICATION

This application claims a priority to Chinese Patent Application No. 202110980060.4 filed on Aug. 25, 2021, the disclosure of which is incorporated in its entirety by reference herein.

### TECHNICAL FIELD

The present disclosure relates to the field of artificial intelligent technology, in particular to the field of computer vision technology and deep learning technology, more particularly to a 3D object detection method, a model training method, relevant devices, and an electronic apparatus.

### BACKGROUND

Along with the rapid development of the image processing technology, 3D object detection has been widely used. The 3D object detection of a monocular image refers to performing the 3D object detection on the basis of the monocular image to obtain detection information in a 3D space.

Usually, the 3D object detection of the monocular image is performed on the basis of an RGB color image in combination with geometric constraint or semantic knowledge. Alternatively, depth estimation is performed on the monocular image, and then the 3D object detection is performed in accordance with depth information and an image feature.

### SUMMARY

An object of the present disclosure is to provide a quantum-gate 3D object detection method, a model training method, relevant devices and an electronic device, so as to solve problems in the related art.

In a first aspect, the present disclosure provides in some embodiments a 3D object detection method realized by a computer, including: obtaining a first monocular image; and inputting the first monocular image into an object model, and performing a first detection operation to obtain first detection information in a 3D space, wherein the first detection operation includes performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information, wherein the target learning parameter is used to present a difference degree between the first point cloud feature and a target point cloud feature of the first monocular image.

In a second aspect, the present disclosure provides in some embodiments a model training method realized by a computer, including: obtaining train sample data, the train sample data including a second monocular image, a point cloud feature tag corresponding to the second monocular image and a detection tag in a 3D space; inputting the second monocular image into an object model, and performing a second detection operation to obtain second detection information in the 3D space, the second detection operation including performing feature extraction in accordance with the second monocular image to obtain a third point cloud feature, performing feature distillation on the third point cloud feature in accordance with the point cloud feature tag to obtain a fourth point cloud feature and a target learning parameter, and performing 3D object detection in accordance with the fourth point cloud feature to obtain the second detection information, the target learning parameter being a learning parameter through which a difference between the fourth point cloud feature and the point cloud feature tag is smaller than a predetermined threshold; determining a loss of the object model, the loss including the difference between the point cloud feature tag and the fourth point cloud feature and a difference between the detection tag and the second detection information; and updating a network parameter of the object model in accordance with the loss.

In a third aspect, the present disclosure provides in some embodiments a 3D objet detection device, including: a first obtaining module configured to obtain a first monocular image; and a first execution module configured to input the first monocular image into an object model, and perform a first detection operation to obtain first detection information in a 3D space, wherein the first detection operation includes performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information, wherein the target learning parameter is used to present a difference degree between the first point cloud feature and a target point cloud feature of the first monocular image.

In a fourth aspect, the present disclosure provides in some embodiments a model training device, including: a second obtaining module configured to obtain train sample data, the train sample data including a second monocular image, a point cloud feature tag corresponding to the second monocular image and a detection tag in a 3D space; a second execution module configured to input the second monocular image into an object model, and perform a second detection operation to obtain second detection information in the 3D space, the second detection operation including performing feature extraction in accordance with the second monocular image to obtain a third point cloud feature, performing feature distillation on the third point cloud feature in accordance with the point cloud feature tag to obtain a fourth point cloud feature and a target learning parameter, and performing 3D object detection in accordance with the fourth point cloud feature to obtain the second detection information, the target learning parameter being a learning parameter through which a difference between the fourth point cloud feature and the point cloud feature tag is smaller than a predetermined threshold; a model loss determination module configured to determine a loss of the object model, the loss including the difference between the point cloud feature tag and the fourth point cloud feature and a difference between the detection tag and the second detection information; and a network parameter updating module configured to update a network parameter of the object model in accordance with the loss.

In a fifth aspect, the present disclosure provides in some embodiments an electronic apparatus, including at least one processor and a memory in communication with the at least one processor. The memory is configured to store therein an instruction to be executed by the at least one processor, and the instruction is executed by the at least one processor so as to implement the 3D object detection method in the first aspect, or the model training method in the second aspect.

In a sixth aspect, the present disclosure provides in some embodiments a non-transitory computer-readable storage medium storing therein a computer instruction. The computer instruction is executed by a computer so as to implement the 3D object detection method in the first aspect, or the model training method in the second aspect.

In a seventh aspect, the present disclosure provides in some embodiments a computer program product including a computer program. The computer program is executed by a processor so as to implement the 3D object detection method in the first aspect, or the model training method in the second aspect.

According to the embodiments of the present disclosure, it is able to solve the problem that the 3D object detection has relatively low accuracy, thereby to improve the accuracy of the 3D object detection.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings,

FIG. 1 is a flow chart of a 3D object detection method according to a first embodiment of the present disclosure;

FIG. 2 is a schematic view showing a first detection operation performed by an object model according to one embodiment of the present disclosure;

FIG. 3 is a flow chart of a model training method according to a second embodiment of the present disclosure;

FIG. 4 is a schematic view showing a framework for the training of the object model according to one embodiment of the present disclosure;

FIG. 5 is a schematic view showing a 3D object detection device according to a third embodiment of the present disclosure;

FIG. 6 is a schematic view showing a model training device according to a fourth embodiment of the present disclosure; and

FIG. 7 is a block diagram of an electronic apparatus according to one embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

First Embodiment

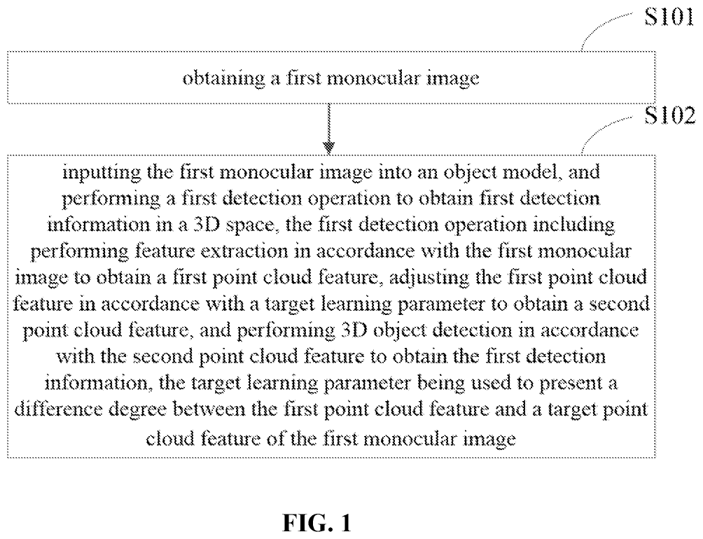

As shown in FIG. 1, the present disclosure provides in this embodiment a 3D object detection method which includes the following steps.

Step S101: obtaining a first monocular image.

In the embodiments of the present disclosure, the 3D object detection method relates to the field of Artificial Intelligence (AI) technology, in particular to the field of computer vision technology and deep learning technology, and it may be widely applied to a monocular 3D object detection scenario, i.e., to perform the 3D object detection on a monocular image. The 3D object detection method may be implemented by a 3D object detection device in the embodiments of the present disclosure. The 3D object detection device may be provided in any electronic apparatus, so as to implement the 3D object detection method. The electronic apparatus may be a server or a terminal, which will not be particularly defined herein.

In this step, the monocular image is described relative to a binocular image and a multinocular image. The binocular image refers to a left-eye image and a right-eye image captured in a same scenario, the multinocular image refers to a plurality of images captured in a same scenario, and the monocular image refers to an individual image captured in a same scenario.

An object of the method is to perform the 3D object detection on the monocular image, so as to obtain detection information about the monocular image in a 3D space. The detection information includes a 3D detection box for an object in the monocular image. In a possible scenario, when the monocular image includes vehicle image data, the 3D object detection may be performed on the monocular image, so as to obtain a category of the object and the 3D detection box for a vehicle. In this way, it is able to determine the category of the object and a position of the vehicle in the monocular image.

The first monocular image may be an RGB color image or a grayscale image, which will not be particularly defined herein.

The first monocular image may be obtained in various ways. For example, an image may be captured by a monocular camera as the first monocular image, or a pre-stored monocular image may be obtained as the first monocular image, or a monocular image may be received from the other electronic apparatus as the first monocular image, or an image may be downloaded from a network as the first monocular image.

Step S102: inputting the first monocular image into an object model, and performing a first detection operation to obtain first detection information in a 3D space. The first detection operation includes performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information, wherein the target learning parameter is used to present a difference degree between the first point cloud feature and a target point cloud feature of the first monocular image.

In this step, the object model may be a neural network model, e.g., a convolutional neural network or a residual neural network ResNet. The object model may be used to perform the 3D object detection on the monocular image. An input of the object model may be any image, and an output thereof may be detection information about the image in the 3D space. The detection information may include the category of the object and the 3D detection box for the object.

The first monocular image may be inputted into the object model for the first detection operation, and the object model may perform the 3D target detection on the first monocular image to obtain the first detection information in the 3D space. The first detection information includes the category of the object in the first monocular image and the 3D detection box for the object. The category of the object refers to a categorical attribute of the object in the first monocular image, e.g., vehicle, cat or human-being. The 3D detection box refers to a box indicating a specific position of the object in the first monocular image. The 3D detection box includes a length, a width and a height, and a directional angle is provided to represent a direction in which the object faces in the first monocular image.

To be specific, the first detection operation may include three parts, i.e., the extraction of the point cloud feature, the distillation of the point cloud feature, and the 3D object detection in accordance with the point cloud feature.

The extraction of the point cloud feature refers to extracting the point cloud feature in accordance with the first monocular image to obtain the first point cloud feature. The first point cloud feature may be a feature relative to a point cloud 3D image corresponding to the first monocular image, i.e., it may be a feature in the 3D space. As compared with a feature related to a two-dimensional (2D) image, the first point cloud feature has an image depth image. The point cloud 3D image may be represented by a Bird's Eye View (BEV), so the first point cloud feature may also be called as a BEV feature, i.e., a feature related to a BEV corresponding to the first monocular image.

The point cloud feature may be extracted in various ways. In a possible embodiment of the present disclosure, depth estimation may be performed on the first monocular image to obtain depth information, point could data about the first monocular image may be determined in accordance with the depth information, the 2D image feature may be converted into voxel data in accordance with the point cloud data, and then the point could feature may extracted in accordance with the voxel data to obtain a voxel image feature, i.e., the first point cloud feature.

In another possible embodiment of the present disclosure, depth estimation may be performed on the first monocular image to obtain depth information, point could data about the first monocular image may be determined in accordance with the depth information, the point cloud data may be converted into a BEV, and then the point cloud feature may be in accordance with the BEV to obtain the first point cloud feature.

The distillation of the point cloud feature refers to the distillation of a feature capable of representing the target point cloud feature of the first monocular image from the first point cloud feature, i.e., the distillation of a feature similar to the target point cloud feature. The target point cloud feature refers to a point cloud feature extracted in accordance with a point cloud data tag of the first monocular image, and it may also be called as point cloud feature tag. The point cloud data tag may be accurate point cloud data collected by a laser radar in a same scenario as the first monocular image.

The distillation may be performed on the first point cloud feature in accordance with the target learning parameter, so as to obtain the second point cloud feature similar to the target point cloud feature. To be specific, the first point cloud feature may be adjusted in accordance with the target learning parameter to obtain the second point cloud feature.

The target learning parameter may be used to represent the difference degree between the first point cloud feature and the second point cloud feature, and it is obtained through training the object model. In a possible embodiment of the present disclosure, the target learning parameter may include a feature difference of pixel points between the first point cloud feature and the target point cloud feature. Correspondingly, a feature value of each pixel point in the first point cloud feature may be adjusted in accordance with the feature difference, so as to obtain the second point cloud feature similar to the target point cloud feature.

In another possible embodiment of the present disclosure, the target learning parameter may be specifically used to present a distribution difference degree between the first point cloud feature and the target point cloud feature. The target learning parameter may include a distribution average difference and a distribution variance difference between the first point cloud feature and the target point cloud feature.

In the embodiments of the present disclosure, the first point cloud feature is BEV_{img}, and the target learning parameter is (Δμ_{img}, Δσ_{img}). The step of adjusting the first point cloud feature in accordance with the target learning parameter specifically includes: calculating an average and a variance of BEV_{img}, marked as (μ_{img}, σ_{img}); normalizing BEV_{img} in accordance with the average and the variance, so as to obtain a normalized first point cloud feature represented by B̅E̅V̅_{img}, and

$${\overline{BEV}}_{i m g} = \frac{B E {V}_{img} - {μ}_{img}}{{σ}_{img}} ;$$

and adjusting the normalized first point cloud feature in accordance with the target learning parameter through the following formula (1) to obtain the second point cloud feature: [symbol] _{img}=B̅E̅V̅_{img}*Δσ_{img}+Δμ_{img}(1), where [symbol] _{img} represents the second point cloud feature.

Next, the 3D target detection may be performed in accordance with the second point cloud feature using an existing or new detection method, so as to obtain the first detection information. A specific detection method will not be particularly defined herein.

It should be appreciated that, before use, the object model needs to be trained, so as to learn parameters of the object model including the target learning parameter. A training process will be described hereinafter in details.

According to the embodiments of the present disclosure, the point cloud feature may be extracted through the object model in accordance with the first monocular image to obtain the first point cloud feature. The first point cloud feature may be distillated in accordance with the target learning parameter to obtain the second point cloud feature similar to the target point cloud feature. Then, the 3D target detection may be performed in accordance with the second point cloud feature to obtain the first detection information. As a result, through the extraction and distillation of the point cloud features on the monocular image using the object model, the feature obtained from the monocular image may be similar to the target point cloud feature, so it is able to improve the accuracy of the monocular 3D object detection.

In a possible embodiment of the present disclosure, the performing the feature extraction in accordance with the first monocular image to obtain the first point cloud feature includes: performing depth prediction on the first monocular image to obtain depth information about the first monocular image; converting pixel points in the first monocular image into first 3D point cloud data in accordance with the depth information and a camera intrinsic parameter corresponding to the first monocular image; and performing feature extraction on the first 3D point cloud data to obtain the first point cloud feature.

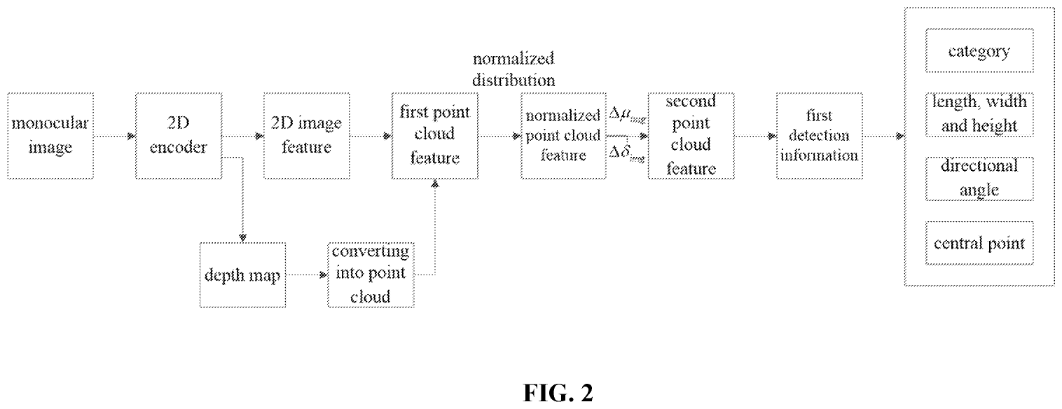

In the embodiments of the present disclosure, the object model performs the first detection operation as shown in FIG. 2. The object model may include a 2D encoder and a network branch for predicting the depth of the monocular image. The 2D encoder is configured to extract a 2D image feature of the first monocular image, and the network branch for predicting the depth of the monocular image is connected in series to a 2D image editor.

The depth estimation may be performed on the first monocular image to obtain the depth information, the point cloud data about the first monocular image may be determined in accordance with the depth information, the 2D image feature may be converted into voxel data in accordance with the point cloud data, and then the point cloud feature may be extract in accordance with the voxel data to obtain a voxel image feature as the first point cloud feature.

To be specific, an RGB color image with a size of W*H is taken as an input of the object model, and the network branch performs depth prediction on the RGB color image using an existing or new depth prediction method, so as to obtain depth information about the RGB color image.

The point cloud data about the first monocular image is determined in accordance with the depth information. In a possible embodiment of the present disclosure, each pixel point in the first monocular image may be converted into a 3D point cloud in accordance with the depth information and the camera intrinsic parameter corresponding to the first monocular image. To be specific, the camera intrinsic parameter is

$$K = [ \begin{matrix}{f}_{x} & 0 & {c}_{x} \\ 0 & {f}_{y} & {c}_{y} \\ 0 & 0 & 1\end{matrix} ] ,$$

a predicted depth map is D (u, v), and each pixel point in the first monocular image is marked as I(u, v). The pixel point may be converted into the 3D point cloud in accordance with the camera intrinsic parameter and the depth map through the following formula:

$$D [ \begin{matrix}u \\ v \\ 1\end{matrix} ] = K {P}_{c} = [ \begin{matrix}{f}_{x} & 0 & {c}_{x} \\ 0 & {f}_{y} & {c}_{y} \\ 0 & 0 & 1\end{matrix} ] [ \begin{matrix}x \\ y \\ z\end{matrix} ] , \qquad ( 2 )$$

where P_{c} represents the 3D point cloud. Through the transformation of the above formula (2), P_{c} may be expressed by

$${P}_{c} = D {K}^{- 1} [ \begin{matrix}u \\ v \\ 1\end{matrix} ] = {[ \begin{matrix}{f}_{x} & 0 & {c}_{x} \\ 0 & {f}_{y} & {c}_{y} \\ 0 & 0 & 1\end{matrix} ]}^{- 1} [ \begin{matrix}u \\ v \\ 1\end{matrix} ] . \qquad ( 3 )$$

With respect to each 3D point, the 2D image feature may be converted into a voxel in accordance with the 3D point to obtain the voxel data. Then, an existing or new network may be provided in the object model so as to extract the point cloud feature from the voxel data, thereby to obtain a voxel image feature as the first point cloud feature.

In the embodiments of the present disclosure, the depth prediction is performed on the first monocular image to obtain the depth information about the first monocular image. Next, the pixel point in the first monocular image is converted into the first 3D point cloud data in accordance with the depth information and the camera intrinsic parameter corresponding to the first monocular image. Then, the feature extraction is performed on the first 3D point cloud data to obtain the first point cloud feature. In this way, it is able to extract the first point cloud feature from the first monocular image in a simple and easy manner.

In a possible embodiment of the present disclosure, the target learning parameter is used to represent a distribution difference degree between the first point cloud feature and the target point cloud feature. The adjusting the first point cloud feature in accordance with the target learning parameter to obtain the second point cloud feature includes: normalizing the first point cloud feature; and adjusting the normalized first point cloud feature in accordance with the target learning parameter to obtain the second point cloud feature.

In the embodiments of the present disclosure, the target learning parameter may specifically represent the distribution difference degree between the first point cloud feature and the target point cloud feature, and it may include a distribution average difference and a distribution variance difference between the first point cloud feature and the target point cloud feature.

The first point cloud feature is BEV_{img}, and the target learning parameter is (Δμ_{img}, Δσ_{img}), where Δμ_{img} represents the distribution average difference between the first point cloud feature and the target point cloud feature, and Δσ_{img} represents the distribution variance difference between the first point cloud feature and the target point cloud feature.

The step of adjusting the first point cloud feature in accordance with the target learning parameter may specifically include: calculating an average and a variance of BEV_{img}, marked as (μ_{img}, σ_{img}); normalizing BEV_{img} in accordance with the average and the variance to obtain a normalized first point cloud feature B̅E̅V̅_{img}; and adjusting the normalized first point cloud feature in accordance with the target learning parameter through the above formula (1) to obtain the second point cloud feature [symbol] _{img}.

In the embodiments of the present disclosure, in the case that the target learning parameter is used to represent the distribution difference degree between the first point cloud feature and the target point cloud feature, the first point cloud feature is normalized, and then the normalized first point cloud feature is adjusted in accordance with the target learning parameter to obtain the second point cloud feature. In this way, it is able to obtain the second point cloud feature in accordance with the first point cloud feature through distillation in a simple and easy manner.

### Second Embodiment

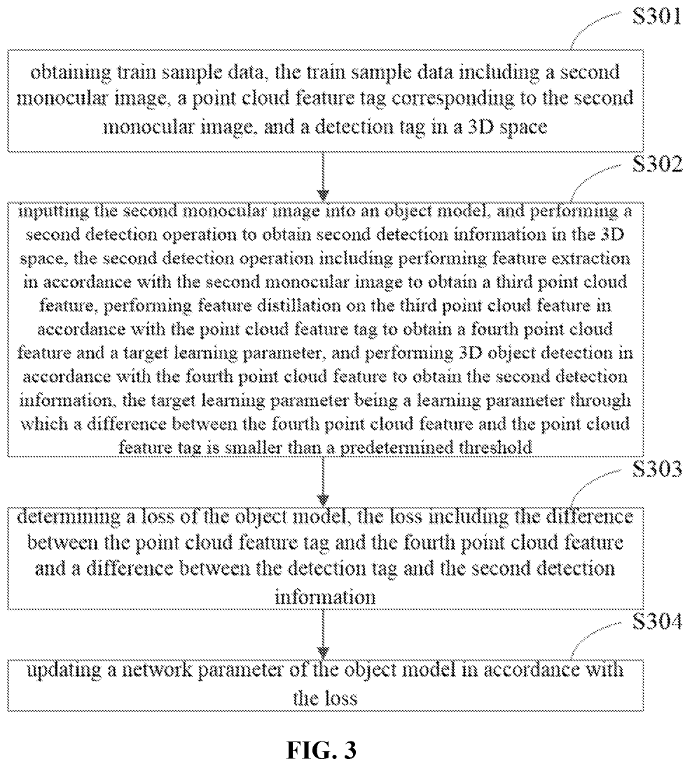

As shown in FIG. 3, the present disclosure provides in this embodiment a model training method, which includes the following steps: S301 of obtaining train sample data, the train sample data including a second monocular image, a point cloud feature tag corresponding to the second monocular image and a detection tag in a 3D space; S302 of inputting the second monocular image into an object model, and performing a second detection operation to obtain second detection information in the 3D space, the second detection operation including performing feature extraction in accordance with the second monocular image to obtain a third point cloud feature, performing feature distillation on the third point cloud feature in accordance with the point cloud feature tag to obtain a fourth point cloud feature and a target learning parameter, and performing 3D object detection in accordance with the fourth point cloud feature to obtain the second detection information, the target learning parameter being a learning parameter through which a difference between the fourth point cloud feature and the point cloud feature tag is smaller than a predetermined threshold; S303 of determining a loss of the object model, the loss including the difference between the point cloud feature tag and the fourth point cloud feature and a difference between the detection tag and the second detection information; and S304 of updating a network parameter of the object model in accordance with the loss.

A training procedure of the object model is described in this embodiment.

In step S301, the train sample data may include a plurality of second monocular images, the point cloud feature tag corresponding to each second monocular image, and the detection tag corresponding to each second monocular image in the 3D space.

The second monocular image in the train sample data may be obtained in one or more ways. For example, a monocular image may be directly captured by a monocular camera as the second monocular image, or a pre-stored monocular image may be obtained as the second monocular image, or a monocular image may be received from the other electronic apparatus as the second monocular image, or a monocular image may be downloaded from a network as the second monocular image.

The point cloud feature tag corresponding to the second monocular image may refer to a point cloud feature extracted in accordance with the point cloud data tag of the second monocular image, and it may be used to accurately represent a feature of the second monocular image. The point cloud data tag of the second monocular image may be accurate point cloud data collected by a laser radar in a same scenario as the second monocular image.

The point cloud feature tag corresponding to the second monocular image may be obtained in various ways. For example, in the case that the point cloud data tag of the second monocular image has been obtained accurately, the point cloud feature extraction may be performed on the point cloud data tag so as to obtain the point clout feature tag, or the point cloud feature tag corresponding to the pre-stored second monocular image may be obtained, or the point cloud feature tag corresponding to the second monocular image may be received from the other electronic apparatus.

The detection gap in the 3D space corresponding to the second monocular image may include a tag representing a category of an object in the second monocular image and a tag representing a 3D detection box for a position of the object in the second monocular image, and it may obtained in various ways. For example, the 3D object detection may be performed on the point cloud feature tag to obtain the detection tag, or the detection tag corresponding to the pre-stored second monocular image may be obtained, or the detection tag corresponding to the second monocular image may be received from the other electronic apparatus.

In a possible embodiment of the present disclosure, the detection tag may be obtained through a point cloud pre-training network model with constant parameters, e.g. a point cloud 3D detection framework Second or PointPillars. A real radar point cloud corresponding to the second monocular image may be inputted into the point cloud pre-training network model for 3D object detection, an intermediate feature map may be the point cloud feature tag, and an output may be the detection tag corresponding to the second monocular image.

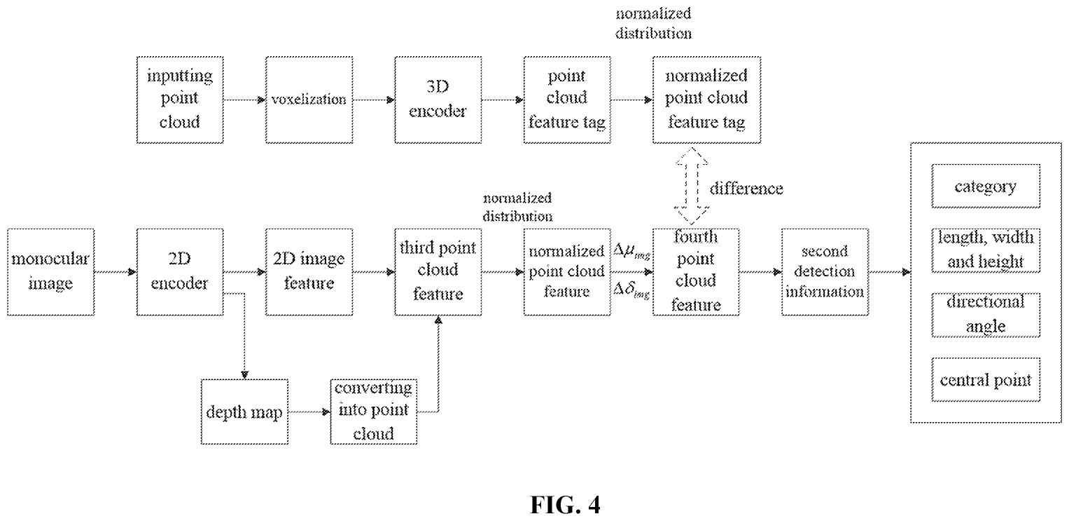

FIG. 4 shows a framework for the training of the object model. A real radar point cloud may be inputted into the point cloud pre-training network model. Next, the voxelization may be performed by the point cloud pre-training network model on the real radar point cloud to obtain voxel data. Next, the feature extraction may be performed through a 3D encoder to obtain a point cloud feature tag BEV cloud. Then, the point cloud feature tag may be normalized to obtain a normalized point cloud feature tag B̅E̅V̅_{cloud}.

In step S302, the second monocular image may be inputted into the object model for the second detection operation, so as to obtain the second detection information. The second detection operation may also include the extraction of the point cloud feature, the distillation of the point cloud feature, and the 3D object detection in accordance with the point cloud feature.

The extraction of the point cloud feature in the second detection operation is similar to that in the first detection operation, and the 3D object detection in accordance with the point cloud feature in the second detection operation is similar to that in the first detection operation, which will thus not be particularly defined herein.

The point cloud feature may be distilled in various ways in the second detection operation. In a possible embodiment of the present disclosure, an initial learning parameter may be set, and it may include a feature difference between pixel points in two point cloud features. A feature value of each pixel point in the third point cloud feature may be adjusted in accordance with the initial learning parameter to obtain another point cloud feature. Next, a feature difference between pixel points in the point cloud feature obtained through adjustment and the point cloud feature tag may be determined, and then the initial learning parameter may be adjusted in accordance with the feature difference for example through a gradient descent method, so as to finally obtain the target learning parameter.

The target learning parameter may include a feature difference between pixel points in the third point cloud feature and the target point cloud feature, and a feature value of each pixel point in the third point cloud feature may be adjusted in accordance with the feature difference so as to obtain the fourth point cloud feature similar to the point cloud feature tag.

In another possible embodiment of the present disclosure, an initial learning parameter may be set to represent a distribution difference between two point cloud features. The distribution of the third point cloud feature may be adjusted in accordance with the initial learning parameter to obtain another point cloud feature. Next, a distribution difference between the point cloud feature obtained through adjustment and the point cloud feature tag may be determined, and then the initial learning parameter may be adjusted in accordance with the feature difference for example through a gradient descent method, so as to finally obtain the target learning parameter.

The target learning parameter may specifically represent a distribution difference degree between the third point cloud feature and the point cloud feature tag, and it may include a distribution average difference and a distribution variance difference between the third point cloud feature and the point cloud feature tag. The distribution of the third point cloud feature may be adjusted in accordance with the distribution average difference and the distribution variance difference, so as to obtain the fourth point cloud feature distributed in a similar way as the point cloud feature tag.

In addition, content in the second detection information is similar to that in the first detection information, and thus will not be particularly defined herein.

In step S303, the loss of the object model may be determined, and it may include a difference between the point cloud feature tag and the fourth point cloud feature and a difference between the detection tag and the second detection information. To be specific, the loss of the object model may be calculated through L=L_{distill}+L_{class}+L_{box3d} (4), where L represents the loss of the object model, L_{distill} represents the difference between the point cloud feature tag and the fourth point cloud feature and L_{distill}=∥ [symbol] _{img}−B̅E̅V̅_{cloud}∥_{L2}, L_{class} represents a difference between a tag of category of an object in the detection tag and a category of an object in the second detection information, L_{box3d} represents a difference between a 3D detection box in the detection tag and a 3D detection box in the send detection information, and it includes a difference between lengths of the two 3D detection boxes, a difference between widths of the two 3D detection boxes, a difference between heights of the two 3D detection boxes, and a difference between directional angles of the two 3D detection boxes.

In step S304, the network parameter of the object model may be updated in accordance with the loss through a gradient descent method. The training of the object model is completed until the loss of the object model is smaller than a certain threshold and convergence has been achieved.

According to the embodiments of the present disclosure, the train sample data is obtained, and the train sample data includes the second monocular image, the point cloud feature tag corresponding to the second monocular image and the detection tag in the 3D space. Next, the second monocular image is inputted into the object model, and the second detection operation is performed to obtain second detection information in the 3D space. The second detection operation includes performing the feature extraction in accordance with the second monocular image to obtain the third point cloud feature, performing the feature distillation on the third point cloud feature in accordance with the point cloud feature tag to obtain the fourth point cloud feature and the target learning parameter, and performing the 3D object detection in accordance with the fourth point cloud feature to obtain the second detection information, and the target learning parameter is a learning parameter through which a difference between the fourth point cloud feature and the point cloud feature tag is smaller than the predetermined threshold. Next, the loss of the object model is determined, and the loss includes the difference between the point cloud feature tag and the fourth point cloud feature and the difference between the detection tag and the second detection information. Then, the network parameter of the object model is updated in accordance with the loss. As a result, it is able to train the object model and perform the 3D object detection on the monocular image through the object mode, thereby to improve the accuracy of the monocular 3D object detection.

In a possible embodiment of the present disclosure, the performing the feature distillation on the third point cloud feature in accordance with the point cloud feature tag to obtain the fourth point cloud feature and the target learning parameter includes: normalizing the third point cloud feature and the point cloud feature tag; adjusting the normalized third point cloud feature in accordance with a learning parameter to obtain a fifth point cloud feature; determining a difference between the fifth point cloud feature and the normalized point cloud feature tag; and updating the learning parameter in accordance with the difference between the fifth point cloud feature and the normalized point cloud feature tag, so as to obtain the target learning parameter and the fourth point cloud feature.

In the embodiments of the present disclosure, the third point cloud feature and the point cloud feature tag may be normalized in a way similar to the first point cloud feature, which will thus not be particularly defined herein.

An initial learning parameter may be set, and it may represent a distribution difference between two point cloud features. The distribution of the third point cloud feature (the normalized third point cloud feature) may be adjusted in accordance with the initial learning parameter to obtain another point cloud feature, i.e., the fifth point cloud feature. Next, a distribution difference between the fifth point cloud feature and the point cloud feature tag, i.e., a difference between the fifth point cloud feature and the normalized point cloud feature, may be determined. Then, the initial learning parameter may be adjusted in accordance with the distribution difference for example through a gradient descent method, so as to obtain the target learning parameter.

The target learning parameter may specifically represent a distribution difference degree between the third point cloud feature and the point cloud feature tag, and it may include a distribution average difference and a distribution variance difference between the third point cloud feature and the point cloud feature tag. The distribution of the third point cloud feature may be adjusted in accordance with the distribution average difference and the distribution variance difference, so as to obtain the fourth point cloud feature distributed in a way similar to the point cloud feature tag.

In a training process, at first the target learning parameter may be determined, and the loss of the object model may be determined in accordance with the target learning parameter to update the network parameter of the object model. Then, because the third point cloud feature has been updated, the target learning parameter may be updated again in accordance with the updated network parameter of the object model, until the loss of the object model is smaller than a certain threshold and convergence has been achieved. At this time, the latest network parameter and the target learning parameter may be used for the actual monocular 3D object detection.

In the embodiments of the present disclosure, the third point cloud feature and the point cloud feature tag are normalized. The normalized third point cloud feature is adjusted in accordance with the learning parameter to obtain the fifth point cloud feature. Then, the difference between the fifth point cloud feature and the normalized point cloud feature tag is determined, and the learning parameter is updated in accordance with the difference so as to obtain the target learning parameter and the fourth point cloud feature. In this way, it is able to perform the point cloud feature distillation on the third point cloud feature in the training process of the object model, thereby to obtain the fourth point cloud feature similar to the point cloud feature tag in a simple and easy manner.

### Third Embodiment

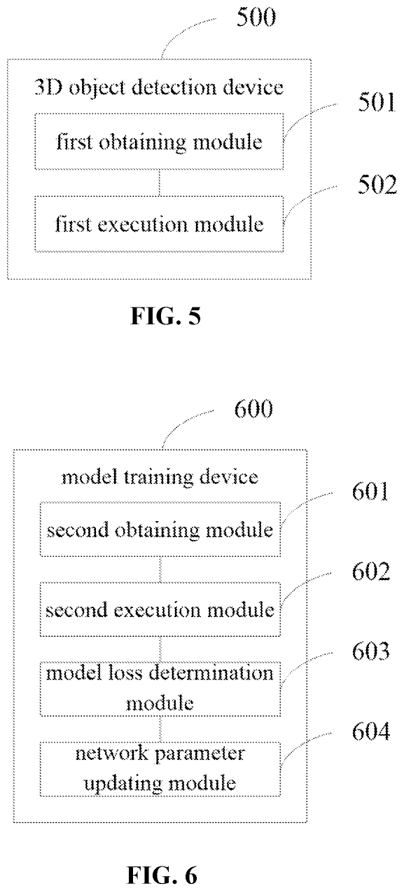

As shown in FIG. 5, the present disclosure provides in this embodiment a 3D object detection device 500, which includes: a first obtaining module 501 configured to obtain a first monocular image; and a first execution module 502 configured to input the first monocular image into an object model, and perform a first detection operation to obtain first detection information in a 3D space. The first detection operation includes performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information. The target learning parameter is used to present a difference degree between the first point cloud feature and a target point cloud feature of the first monocular image.

In a possible embodiment of the present disclosure, the first execution module 502 includes: a depth prediction unit configured to perform depth prediction on the first monocular image to obtain depth information about the first monocular image; a conversion unit configured to convert pixel points in the first monocular image into first 3D point cloud data in accordance with the depth information and a camera intrinsic parameter corresponding to the first monocular image; and a first feature extraction unit configured to perform feature extraction on the first 3D point cloud data to obtain the first point cloud feature.

In a possible embodiment of the present disclosure, the target learning parameter is used to represent a distribution difference degree between the first point cloud feature and the target point cloud feature. The first execution module 502 includes: a first normalization unit configured to normalize the first point cloud feature; and a first adjustment unit configured to adjust the normalized first point cloud feature in accordance with the target learning parameter to obtain the second point cloud feature.

The 3D object detection device 500 in this embodiment is used to implement the above-mentioned 3D object detection method with a same beneficial effect, which will not be particularly defined herein.

### Fourth Embodiment

As shown in FIG. 6, the present disclosure provides in this embodiment a model training device 600, which includes: a second obtaining module 601 configured to obtain train sample data, the train sample data including a second monocular image, a point cloud feature tag corresponding to the second monocular image and a detection tag in a 3D space; a second execution module 602 configured to input the second monocular image into an object model, and perform a second detection operation to obtain second detection information in the 3D space, the second detection operation including performing feature extraction in accordance with the second monocular image to obtain a third point cloud feature, performing feature distillation on the third point cloud feature in accordance with the point cloud feature tag to obtain a fourth point cloud feature and a target learning parameter, and performing 3D object detection in accordance with the fourth point cloud feature to obtain the second detection information, the target learning parameter being a learning parameter through which a difference between the fourth point cloud feature and the point cloud feature tag is smaller than a predetermined threshold; a model loss determination module 603 configured to determine a loss of the object model, the loss including the difference between the point cloud feature tag and the fourth point cloud feature and a difference between the detection tag and the second detection information; and a network parameter updating module 604 configured to update a network parameter of the object model in accordance with the loss.

In a possible embodiment of the present disclosure, the second execution module 602 includes: a second normalization unit configured to normalize the third point cloud feature and the point cloud feature tag; a second adjustment unit configured to adjust the normalized third point cloud feature in accordance with a learning parameter to obtain a fifth point cloud feature; a feature difference determination unit configured to determine a difference between the fifth point cloud feature and the normalized point cloud feature tag; and a learning parameter updating unit configured to update the learning parameter in accordance with the fifth point cloud feature and the normalized point cloud feature tag, so as to obtain the target learning parameter and the fourth point cloud feature.

The model training device 600 in this embodiment is used to implement the above-mentioned model training method with a same beneficial effect, which will not be particularly defined herein.

The collection, storage, usage, processing, transmission, supply and publication of personal information involved in the embodiments of the present disclosure comply with relevant laws and regulations, and do not violate the principle of the public order.

The present disclosure further provides in some embodiments an electronic apparatus, a computer-readable storage medium and a computer program product.

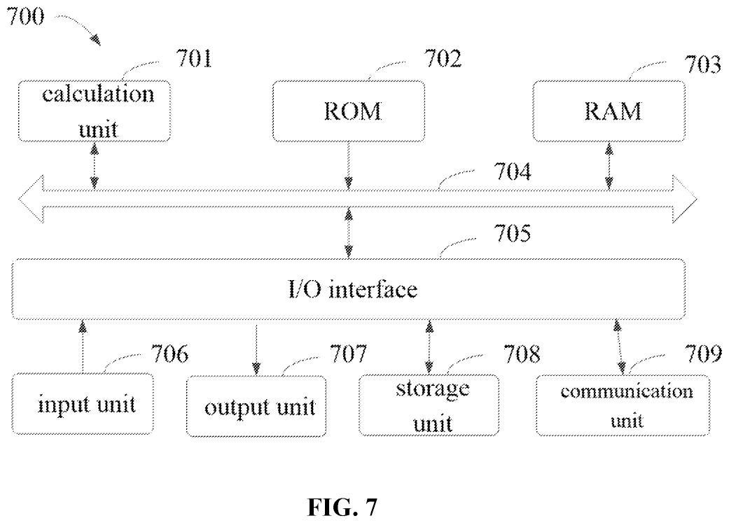

FIG. 7 is a schematic block diagram of an exemplary electronic device 700 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 7, the electronic device 700 includes a computing unit 701 configured to execute various processings in accordance with computer programs stored in a Read Only Memory (ROM) 702 or computer programs loaded into a Random Access Memory (RAM) 703 via a storage unit 708. Various programs and data desired for the operation of the electronic device 700 may also be stored in the RAM 703. The computing unit 701, the ROM 702 and the RAM 703 may be connected to each other via a bus 704. In addition, an input/output (I/O) interface 705 may also be connected to the bus 704.

Multiple components in the electronic device 700 are connected to the I/O interface 705. The multiple components include: an input unit 706, e.g., a keyboard, a mouse and the like; an output unit 707, e.g., a variety of displays, loudspeakers, and the like; a storage unit 708, e.g., a magnetic disk, an optic disk and the like; and a communication unit 709, e.g., a network card, a modem, a wireless transceiver, and the like. The communication unit 709 allows the electronic device 700 to exchange information/data with other devices through a computer network and/or other telecommunication networks, such as the Internet.

The computing unit 701 may be any general purpose and/or special purpose processing components having a processing and computing capability. Some examples of the computing unit 701 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 701 carries out the aforementioned methods and processes, e.g., the 3D object detection method or the model training method. For example, in some embodiments of the present disclosure, the road congestion detection method may be implemented as a computer software program tangibly embodied in a machine readable medium such as the storage unit 708. In some embodiments of the present disclosure, all or a part of the computer program may be loaded and/or installed on the electronic device 700 through the ROM 702 and/or the communication unit 709. When the computer program is loaded into the RAM 703 and executed by the computing unit 701, one or more steps of the foregoing 3D object detection method or the model training method may be implemented. Optionally, in some other embodiments of the present disclosure, the computing unit 701 may be configured in any other suitable manner (e.g., by means of firmware) to implement the 3D object detection method or the model training method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A three-dimensional (3D) object detection method realized by a computer, comprising:
obtaining a first monocular image; and
inputting the first monocular image into an object model, and performing a first detection operation to obtain first detection information in a 3D space,
wherein the first detection operation comprises performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information, wherein the target learning parameter is used to present a difference degree between the first point cloud feature and a target point cloud feature of the first monocular image.

2. The 3D object detection method according to claim 1, wherein the performing the feature extraction in accordance with the first monocular image to obtain the first point cloud feature comprises:
performing depth prediction on the first monocular image to obtain depth information about the first monocular image;
converting pixel points in the first monocular image into first 3D point cloud data in accordance with the depth information and a camera intrinsic parameter corresponding to the first monocular image; and
performing feature extraction on the first 3D point cloud data to obtain the first point cloud feature.

3. The 3D object detection method according to claim 1, wherein the target learning parameter is used to represent a distribution difference degree between the first point cloud feature and the target point cloud feature, wherein the adjusting the first point cloud feature in accordance with the target learning parameter to obtain the second point cloud feature comprises:
normalizing the first point cloud feature; and
adjusting the normalized first point cloud feature in accordance with the target learning parameter to obtain the second point cloud feature.

4. The 3D object detection method according to claim 3, wherein the first point cloud feature is BEV_{img}, and the target learning parameter is (Δμ_{img}, Δσ_{img}), wherein the adjusting the normalized first point cloud feature in accordance with the target learning parameter comprises: calculating an average and a variance of BEV_{img}, marked as (μ_{img}, σ_{img}); normalizing BEV_{img} in accordance with the average and the variance, so as to obtain a normalized first point cloud feature represented by B̅E̅V̅_{img}, and
$${\overline{BEV}}_{i m g} = \frac{B E {V}_{img} - {μ}_{img}}{{σ}_{img}} ;$$
and adjusting the normalized first point cloud feature in accordance with the target learning parameter through the following formula to obtain the second point cloud feature: [symbol] _{img}=B̅E̅V̅_{img}*Δσ_{img}+Δμ_{img}, where [symbol] _{img} represents the second point cloud feature.

5. The 3D object detection method according to claim 1, wherein the first point cloud feature refers to a Bird's Eye View (BEV) feature, ant the BEV feature is a feature related to a BEV corresponding to the first monocular image.

6. The 3D object detection method according to claim 2, wherein the performing depth prediction on the first monocular image to obtain depth information about the first monocular image comprises: taking an RGB color image with a size of W*H as an input of the object model, and performing depth prediction on the RGB color image using a depth prediction method, so as to obtain depth information about the RGB color image.

7. A model training method realized by a computer, comprising:
obtaining train sample data, the train sample data comprising a second monocular image, a point cloud feature tag corresponding to the second monocular image and a detection tag in a 3D space;
inputting the second monocular image into an object model, and performing a second detection operation to obtain second detection information in the 3D space, the second detection operation comprising performing feature extraction in accordance with the second monocular image to obtain a third point cloud feature, performing feature distillation on the third point cloud feature in accordance with the point cloud feature tag to obtain a fourth point cloud feature and a target learning parameter, and performing 3D object detection in accordance with the fourth point cloud feature to obtain the second detection information, the target learning parameter being a learning parameter through which a difference between the fourth point cloud feature and the point cloud feature tag is smaller than a predetermined threshold;
determining a loss of the object model, the loss comprising the difference between the point cloud feature tag and the fourth point cloud feature and a difference between the detection tag and the second detection information; and
updating a network parameter of the object model in accordance with the loss.

8. The model training method according to claim 7, wherein the performing the feature distillation on the third point cloud feature in accordance with the point cloud feature tag to obtain the fourth point cloud feature and the target learning parameter comprises:
normalizing the third point cloud feature and the point cloud feature tag;
adjusting the normalized third point cloud feature in accordance with a learning parameter to obtain a fifth point cloud feature;
determining a difference between the fifth point cloud feature and the normalized point cloud feature tag; and
updating the learning parameter in accordance with the difference between the fifth point cloud feature and the normalized point cloud feature tag, so as to obtain the target learning parameter and the fourth point cloud feature.

9. The model training method according to claim 7, wherein the loss of the object model is calculated through L=L_{distill}+L_{class}+L_{box3d} where L represents the loss of the object model, L_{distill} represents the difference between the point cloud feature tag and the fourth point cloud feature, and L_{distill}=∥ [symbol] _{img}−B̅E̅V̅_{cloud}∥_{L2}, L_{class} represents a difference between a tag of category of an object in the detection tag and a category of an object in the second detection information, L_{box3d} represents a difference between a 3D detection box in the detection tag and a 3D detection box in the send detection information, and L_{box3d} comprises a difference between lengths of the two 3D detection boxes, a difference between widths of the two 3D detection boxes, a difference between heights of the two 3D detection boxes, and a difference between directional angles of the two 3D detection boxes.

10. An electronic device realized by a computer, comprising at least one processor and a memory in communication with the at least one processor, wherein the memory is configured to store therein an instruction executed by the at least one processor, and the at least one processor is configured to enable the electronic device to execute the instruction so as to implement a three-dimensional (3D) object detection method realized by the computer, comprising:
obtaining a first monocular image; and
inputting the first monocular image into an object model, and performing a first detection operation to obtain first detection information in a 3D space,
wherein the first detection operation comprises performing feature extraction in accordance with the first monocular image to obtain a first point cloud feature, adjusting the first point cloud feature in accordance with a target learning parameter to obtain a second point cloud feature, and performing 3D object detection in accordance with the second point cloud feature to obtain the first detection information, wherein the target learning parameter is used to present a difference degree between the first point cloud feature and a target point cloud feature of the first monocular image.

11. The electronic device according to claim 10, wherein the performing the feature extraction in accordance with the first monocular image to obtain the first point cloud feature comprises:
performing depth prediction on the first monocular image to obtain depth information about the first monocular image;
converting pixel points in the first monocular image into first 3D point cloud data in accordance with the depth information and a camera intrinsic parameter corresponding to the first monocular image; and
performing feature extraction on the first 3D point cloud data to obtain the first point cloud feature.

12. The electronic device according to claim 10, wherein the target learning parameter is used to represent a distribution difference degree between the first point cloud feature and the target point cloud feature, wherein the adjusting the first point cloud feature in accordance with the target learning parameter to obtain the second point cloud feature comprises:
normalizing the first point cloud feature; and
adjusting the normalized first point cloud feature in accordance with the target learning parameter to obtain the second point cloud feature.

13. The electronic device according to claim 12, wherein the first point cloud feature is BEV_{img}, and the target learning parameter is (Δμ_{img}, Δσ_{img}), wherein the adjusting the normalized first point cloud feature in accordance with the target learning parameter comprises: calculating an average and a variance of BEV_{img}, marked as (μ_{img}, σ_{img}); normalizing BEV_{img} in accordance with the average and the variance, so as to obtain a normalized first point cloud feature represented by B̅E̅V̅_{img}, and
$${\overline{BEV}}_{i m g} = \frac{B E {V}_{img} - {μ}_{img}}{{σ}_{img}} ;$$
and adjusting the normalized first point cloud feature in accordance with the target learning parameter through the following formula to obtain the second point cloud feature: [symbol] _{img}=B̅E̅V̅_{img}*Δσ_{img}+Δμ_{img}, where [symbol] _{img} represents the second point cloud feature.

14. The electronic device according to claim 10, wherein the first point cloud feature refers to a Bird's Eye View (BEV) feature, ant the BEV feature is a feature related to a BEV corresponding to the first monocular image.

15. The electronic device according to claim 11, wherein the performing depth prediction on the first monocular image to obtain depth information about the first monocular image comprises: taking an RGB color image with a size of W*H as an input of the object model, and performing depth prediction on the RGB color image using a depth prediction method, so as to obtain depth information about the RGB color image.

16. An electronic device realized by a computer, comprising at least one processor and a memory in communication with the at least one processor, wherein the memory is configured to store therein an instruction executed by the at least one processor, and the at least one processor is configured to enable the electronic device to execute the instruction so as to implement the model training method realized by the computer according to claim 7.

17. The electronic device according to claim 16, wherein the performing the feature distillation on the third point cloud feature in accordance with the point cloud feature tag to obtain the fourth point cloud feature and the target learning parameter comprises:
normalizing the third point cloud feature and the point cloud feature tag;
adjusting the normalized third point cloud feature in accordance with a learning parameter to obtain a fifth point cloud feature;
determining a difference between the fifth point cloud feature and the normalized point cloud feature tag; and
updating the learning parameter in accordance with the difference between the fifth point cloud feature and the normalized point cloud feature tag, so as to obtain the target learning parameter and the fourth point cloud feature.

18. The electronic device according to claim 16, wherein the loss of the object model is calculated through L=L_{distill}+L_{class}+L_{box3d}, where L represents the loss of the object model, L_{distill} represents the difference between the point cloud feature tag and the fourth point cloud feature, and L_{distill}=∥ [symbol] _{img}−B̅E̅V̅_{cloud}∥_{L2}, L_{class} represents a difference between a tag of category of an object in the detection tag and a category of an object in the second detection information, L_{box3d} represents a difference between a 3D detection box in the detection tag and a 3D detection box in the send detection information, and L_{box3d} comprises a difference between lengths of the two 3D detection boxes, a difference between widths of the two 3D detection boxes, a difference between heights of the two 3D detection boxes, and a difference between directional angles of the two 3D detection boxes.

19. A non-transitory computer-readable storage medium storing therein a computer instruction, wherein the computer instruction is executed by a computer so as to implement the 3D object detection method according to claim 1.

20. A non-transitory computer-readable storage medium storing therein a computer instruction, wherein the computer instruction is executed by a computer so as to implement the model training method according to claim 7.
